(19) United States
(12) Patent Application Publication
(10) Pub. No.: US 2026/0009552 A1
(43) Pub. Date: Jan. 8, 2026

(54) QUANTUM COMPUTING FOR REAL-TIME BUILDING HVAC CONTROLS

(71) Applicants: Bing Dong, Manlius, NY (US); Zhipeng Deng, Syracuse, NY (US); Xuezheng Wang, Syracuse, NY (US)

(72) Inventors: Bing Dong, Manlius, NY (US); Zhipeng Deng, Syracuse, NY (US); Xuezheng Wang, Syracuse, NY (US)

(73) Assignee: Syracuse University, Syracuse, NY (US)

(21) Appl. No.: 19/133,775

(22) PCT Filed: Nov. 29, 2023
(86) PCT No.: PCT/US2023/081624

§ 371 Date: May 29, 2025

Related U.S. Application Data
(60) Provisional application No. 63/428,592, filed on Nov. 29, 2022.

(51) Int. Cl. F24F 11/63; F24F 11/46; F24F 110/10; F24F 120/10; G06N 10/40; G06N 10/60

(52) U.S. Cl. CPC F24F 11/63; F24F 11/46; G06N 10/40; G06N 10/60; F24F 2110/10; F24F 2120/10

(57) ABSTRACT

An optimization solution based on quantum annealing for model predictive control (MPC) of a rooftop unit (RTU) for minimizing energy usage. The solution achieved less than 2 percent differences from conventional approaches and improved computational speed from hours to seconds. The solution also demonstrated an 80% reduction in total electric usage and a 21 percent electric bill reduction considering day-ahead price time-of-use demand response signals.

### BACKGROUND OF THE INVENTION

### 1. Field of the Invention

The present invention related to building control systems and, more specifically, an HVAC system control approach having improved energy efficiency.

### 2. Description of the Related Art

By 2050, a staggering 70% of the world's population is projected to live and work in cities, while two-thirds of global primary energy consumption will be attributed to cities, leading to the production of 71% of the global direct energy-related greenhouse gas (GHG) emissions. People currently spend more than 90% of their time in buildings, which contributes to more than 70% of overall U.S. electricity usage. Such GHG emission contributes to climate change, which is one of the most dominant forces shaping the Earth system and the biggest challenges of the current generation. Many globally recognized environmental and climate threats such as heat stress, abrupt cold snap, air pollution, water scarcity, and energy insecurity are either rooted in or exacerbated by the uniqueness of the urban environment. With the aging of the US building stock, grid, and urban infrastructure, climate threats are expected to further intensify due to the rapid urban development coupled with climate change.

In the US, space heating accounted for 38% of energy delivered in buildings, much more than any other end-use. Meanwhile, electricity used for space cooling by residential and commercial sectors was about 10% of total US electricity consumption. Advanced building controls have demonstrated 20-80% energy savings from literature. It also has a vast potential for sustainable buildings. With energy-saving and sustainability demands, we need optimal control for the building HVAC systems.

Currently, proportional-integral-derivative (PID) controllers were widely used in building automation systems for their simplicity and robustness to achieve conditioned indoor environments. However, it only reacted to current sensor readings without considering any other effects as reactive control. In buildings, there were complex heat transfers and the lagging effects due to the thermal mass of envelopes and indoor sources. They would increase the demands of load on the HVAC system and lead to wasted energy. Therefore, a good control strategy was needed to consider the thermal effects of the buildings and reduce the energy usage while maintaining indoor comfort. Originated from advanced process control, model predictive control (MPC) could capture the dynamics of the building systems. Predictions were calculated with the insights from the physical devices, thus optimal control could be applied to systems with well-defined constraints. The characteristics of MPC made it more prevalent in the control of power systems. With the development of computing tools, MPC was getting more and more attention in the field of building energy. Modeling and optimization could play an important role in sustainable building energy systems. However, most case studies from real-time MPC of building HVAC system has the following characteristics that prevent a large-scale and robust deployment.

### Difficulty in Real-Time Response of MPC

At first, with the uncertainties of the weather forecast, occupancy level, and real-time energy pricing, the MPC required the real-time response to update the control operations. It was necessary to solve the optimization problem within the control time step, such as 15 minutes. But it is very difficult to do real-time MPC for building HVAC systems. Many researchers have tried to develop real-time MPC to reduce the energy consumption by building HVAC systems, such as air handling units (AHU), heat pumps, and variable air volume (VAV) systems. For example, Schirrer et al developed a real-time non-linear MPC for a low-energy office building consisting of the heat pump and solar collector. Even for a 30% variation of weather prediction, it showed good control performance and robustness. Joe and Karava proposed an MPC strategy to optimize the performance of radiant floor heating and cooling systems in office buildings. The electricity consumption of the chiller was three polynomials. They found the controller could save 29-50% of energy compared with a baseline air delivery system. Asad et al developed multiplexed real-time optimization for non-linear dynamics of AHU and achieved 10% energy savings. Ganesh et al used a mass balance model and built a dynamic optimization strategy of AHU for the control of indoor air pollutants. The optimization reduced the pollutant concentration by 31% and energy consumption by 17.7%. As for the VAV system in buildings, it required the optimal control for many different zones, so the number of control variables was usually large, resulting in the difficulty of optimization. Hilliard et al implemented MPC with zone based thermal comfort adjustments for an academic building. The experiments showed 29% HVAC electric reduction. Brooks et al developed occupancy-based energy-efficient MPC for multiple rooms and showed 29-80% energy savings potential. Li et al decomposed the multi-objective optimization of thermal comfort, air quality, and energy use for VAV systems. It effectively found the proper trade-off between maintaining thermal comfort and IAQ and the energy use was only 2% higher. Bengea et al presented field experiment results of MPC which optimized the operation of VAV serving a commercial building. Their demonstration results showed energy savings of 20% during the transition season and 70% during the heating season.

### Inaccuracy Due to Simplified Non-Linear Models

Second, most of the building energy systems were complex and non-linear systems. The non-linearity of the system made the modelling and control very hard, and the optimization results could be inaccurate due to the simplified models. For optimizing the complex non-linear building HVAC systems, previous approaches included multi-stage and multi-level optimization, decomposed, distributed, and decentralized optimization, agent-based method, local approximation and linearization. These methods could not only convert and solve non-linear problems, but also speed up the calculation. For example, Cigler et al outlined an approximation of non-linear optimal control for Predicted Mean Vote index and obtained an additional 10-15% of energy-saving potential. Drgoňa et al developed MPC by decoupling of non-linearities for a ground-source heat pump in an office building and saved 53.5% of energy. Recently, some studies have used machine learning models to solve optimal control for complex building HVAC systems. Such models were easy to build even for the very complicated system. So that machine learning models could do real-time control. But for the robustness of these models in varied environments, the verification from previous studies using the machine learning method only implemented for one or a few days.

### Inefficient solver for discrete variables

In addition, optimizing building HVAC systems usually involved many discrete variables, such as whether or not to use a system component, operating status as on or off, and hierarchical stage control. Current optimization solvers were inefficient for complex problems with many discrete variables. The traditional approach for the optimization of discrete variables was typically a search algorithm. In recent years, mixed-integer linear programming (MILP) and mixed-integer non-linear programming (MINLP) received increasing attention from both academia and industry. Deterministic algorithms for solving large-scale problems were needed to deal with growing subproblem sizes and exponential growth of branch-and-bound trees. In this case, it led to the enumeration of solution alternatives in the feasible space. This method could not deal with the optimization of a complex system in real-time. In addition, meta-heuristics techniques, such as simulated annealing, particle swarm optimization, and genetic algorithm (GA) also became popular nowadays, due to its ease of implementation and low requirement for prior knowledge of the optimization problem. However, these techniques could only solve unconstrained optimization problems. They could not strictly find the global optimum, either. For complex problems that were hard to converge, multiple runs were required to find a better solution. Previously, GA was used to optimize the building HVAC system. People also formulated the optimization of building HVAC systems and net-zero energy building into MILP and used Gurobi and CPLEX software to solve. These traditional optimization methods for large-scale energy systems required a very high computational effort. With the increasing complexity of the problem and more discrete variables to be optimized, the optimization typically required exponential computing time. Finally, the most common technique used to solve real-time building energy management problems was convex optimization. Although for linear optimization, MILP, and quadratic programming, due to the simplicity and convexity, a global solution was guaranteed. Non-linearity of complicated energy systems also made the system modelling and formulating the control strategy very hard. In many engineering optimization problems, the non-convexity of the problem made it impossible to obtain a globally optimal solution.

Developing real-time MPC of a non-linear system for mixed-integer discrete optimization is very challenging. The research gap and challenges are that few previous studies could find the optimal control for the complex non-linear systems with discrete variables within an acceptable computing time. Hence, we needed a better computational tool to solve these optimization problems.

### Quantum Computing

Quantum computing has recently attracted more attention due to its unique ability that was different from ordinary computers in terms of computational principles and speeds. The circuits in a quantum computer obeyed quantum mechanics. The basic unit of a quantum computer was the qubit. A qubit could be in a quantum state of 1 or 0, or a superposition of the two states. However, when measured, it was always 0 or 1; the probability of either outcome depended on the quantum state of qubits immediately before the measurement. Another property of qubit was the ability to form entangled states, allowing to form relationships between separated random behaviors. Quantum computers used these properties of the qubit to perform computations.

Since the computational principle of the quantum computer was different from that of ordinary computers, it provided a novel approach to solving some complex problems with significant speed advantages. For example, Shor proposed the quantum algorithm for factorization of large numbers, which was exponentially faster than any classical algorithm. Due to the potential applications to cryptography, it greatly motivated the development of quantum algorithms. Grover's search algorithm was able to search large databases in the square root of time of complexity. Harrow et al developed a quantum algorithm for solving linear systems of equations. Inspired by these algorithms, many researchers have developed some quantum algorithms for further applications, such as data fitting, clustering, and solving linear differential equations.

As for solving optimization problems, quantum annealing and adiabatic quantum computation relied on the adiabatic theorem. People have built quantum annealers in recent years. In the system, it was initialized in the lowest energy eigenstate of the Hamiltonian. Hamiltonian was a mathematical description of a physical system in terms of energy, corresponding to the objective function of an optimization problem. The slow annealing process evolved the quantum state into a user-defined problem. By reducing the Hamiltonian of the system from a large value to zero, the system was driven to its optimum state as the eigenstate of the quantum Hamiltonian. It could be used for searching optimal solution space effectively. Quantum Hamiltonian in Ising formulation could be expressed as

$${H}_{ising} = - \frac{A ( s )}{2} {\sum }_{i} {\hat{σ}}_{x}^{( i )} + \frac{B ( s )}{2} ( {\sum }_{i} {h}_{i} {\hat{σ}}_{z}^{( i )} + {\sum }_{i > j} {J}_{ij} {\hat{σ}}_{z}^{( i )} {\hat{σ}}_{z}^{( j )} ) \qquad ( 1 )$$

where \hat{σ} was Pauli matrices operating on a qubit qᵢ, A(s) the tunneling energy at annealing fraction s, B(s) the Problem Hamiltonian energy at annealing fraction s, hᵢ the self-interaction energy on a qubit. Jᵢⱼ the coupling energies between spins.

Compared to the traditional optimization algorithm like ant colony optimization algorithm, and simulated annealing to find optimal values, quantum annealing was a more powerful method. It allowed quantum tunneling, which gave a greater probability leading to the ground state under the same conditions of annealing schedule and interaction. It helped get out of the local minimum and could find the global minimum. The recent development of hardware and algorithms of quantum annealer has given people the opportunities to solve very complex optimization problems, even NP-hard problems (Lucas, 2014). To solve an optimization problem using quantum annealing, we first needed to formulate it as unconstrained optimization. With the properties of qubits, then we needed to formulate the continuous or discrete optimization variables into binary variables. When the objective function was a polynomial of variables, it was polynomial unconstrained binary optimization (PUBO), which was a subset of binary optimization as

$$H ( x ) = {\sum }_{S} {C}_{S} {\prod }_{i ∈ S} {x}_{i} \qquad ( 2 )$$

where xᵢ∈{0,1}

The quantum annealer could solve quadratic unconstrained binary optimization (QUBO), where the order of the polynomial in Eq (2) was two that

$$H ( x ) = {\sum }_{i} {C}_{i} {x}_{i} + {\sum }_{i , j} {C}_{ij} {x}_{i} {x}_{j} \qquad ( 3 )$$

where xᵢ,xⱼ∈{0,1}

The first part was linear, and the second part was quadratic and non-linear. Its form was the same as the quantum Hamiltonian in Eq (1), thus we could map the QUBO problem into the quantum processing unit (QPU) and solve it by quantum annealing.

Recently, some researchers were trying to develop algorithms and use quantum annealers to solve optimization problems, especially complex multivariable optimization. For example, Ajagekar and You developed novel quantum computing-based hybrid solution strategies for molecular design and facility location-allocation for energy systems infrastructure development, unit commitment of electric power systems operations, and heat exchanger network synthesis. Ding et al applied quantum annealing for network design and analysis. Castillo et al optimized the refinery scheduling process with a quantum annealer. Quantum annealing could also optimize the power network and water distribution network. The results of the optimization were found to be very good. At last, the quantum annealer also had the potential to solve more problems, such as the optimization of machine learning models. However, quantum computing method has never been used for optimizing the model predictive control of building HVAC systems. Accordingly, there is a need in the art for a quantum computing approach that can optimize building HVAC systems.

### BRIEF SUMMARY OF THE INVENTION

The present invention comprises a new optimization solution based on quantum annealing for Model predictive control (MPC) of a rooftop unit (RTU). The purpose of the present invention was to apply quantum computing (QC) to optimize energy-efficient MPC of building HVAC systems. MPC optimization of the RTU is performed by treating optimization as quadratic unconstrained binary optimization (QUBO) problem. To verify feasibility, a quantum computer was used to solve such the optimization problem, which provided successful results. The results and computing time of quantum computing were compared with traditional optimization methods. Compared to traditional methods, an embodiment of the present invention obtained similar solutions with less than 2% differences and improved computational speed from hours to mere seconds. The present invention was also able to demonstrate an 80% reduction in total electric usage and a 21% electric bill reduction considering day-ahead price time-of-use demand response signals. Quantum computing applied according to the present invention thus has the ability to solve large-scale non-linear discrete optimization problems for building energy systems.

In one embodiment, the present invention may be a controller for a building heating, ventilation, and air conditioning (HVAC) system that has a processor programmed to implement a model predictive control unit to control the operation of HVC system component, a first input for receiving a desired temperature setting for a location serviced by the HVAC system component, a second input for receiving data from at least one temperature sensor in the location, and a third input for receiving data from at least one occupancy sensor reflecting occupancy in the location. A quantum processing unit is programmed to perform a non-linear model predictive control strategy in real-time and to provide control instructions to the model predictive control unit, wherein the non-linear model predictive control strategy uses a quantum annealer to minimize an amount of energy used to achieve the desired temperature setting over a predetermined prediction horizon. The quantum processing unit may be programmed to perform a non-linear model predictive control strategy in real-time according to a predicted occupancy. The amount of energy used may be based on a coil load of the HVAC system component. The amount of energy may include an electricity price. The controller may further comprise a fourth input for receiving data from at least one flow sensor associated with the HVAC system component. The controller may further comprise a fifth input for receiving data from at least one temperature sensor associated with a flow of air from the HVAC system component. The predetermined prediction horizon may be selected from group consisting of two hours, three hours, six hours, twelve hours, and twenty-four hours.

In another embodiment, the present invention may be a method of controlling a building heating, ventilation, and air conditioning (HVAC) system by providing a controller having a processor programmed to implement a model predictive control unit to control the operation of HVC system component, wherein the controller has a first input that receives a desired temperature setting for a location serviced by the HVAC system component, a second input that receives data from at least one temperature sensor in the location, and a third input that receives data from at least one occupancy sensor reflecting occupancy in the location and then performing a non-linear model predictive control strategy in real-time with a quantum processing unit associated with the controller to provide control instructions to the model predictive control unit, wherein the non-linear model predictive control strategy uses a quantum annealer to minimize an amount of energy used to achieve the desired temperature setting over a predetermined prediction horizon.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic illustrating an overview of an exemplary methodology according to the present invention.

FIG. 2 is a schematic of an HVAC controller equipped with quantum computing for real-time building control according to the present invention.

FIG. 3 is a schematic of an RC network model for the room equipped with RTU.

FIG. 4 is a series of graphs of (a) Ideal penalty functions; (b) penalty function used when the room was occupied; and (c) penalty function used when the room was unoccupied.

FIG. 5 is a series of graphs of the collected data of (a) ambient air temperature; (b) zone air temperature; (c) cooling load by HVAC system; (d) internal heat gain; (e) number of occupants; (f) solar heat gain.

FIG. 6 is a series of graphs of the Hamiltonian distribution of 50 smallest samples at (a) 20th, (b) 70th, and (c) 143rd time steps.

FIG. 7 is a comparison of optimal air temperature control, fan stage, and cooling load between quantum computing and traditional method for (a) 2-hour prediction horizon; (b) 3-hour prediction horizon. And gray shade represents the room was occupied.

FIG. 8 is a comparison of optimal air temperature control, fan stage and cooling load for quantum computing between 6-hour, 12-hour, and 24-hour prediction horizons. Gray shade represents the room was occupied.

FIG. 9 is a graph of the electric price for time-of-use rate and peak day rate in one day.

FIG. 10 is a graph of the ambient air temperature in summer for peak day rate in Los Angeles.

FIG. 11 is a graph of the comparison of optimal air temperature control, fan stage, and cooling load by quantum computing to minimize the electric bill between the prediction horizon of 2 hours, 6 hours, and 24 hours. The red, orange, and blue shades represent the peak day, peak hour, and part-peak hour, respectively.

### DETAILED DESCRIPTION OF THE INVENTION

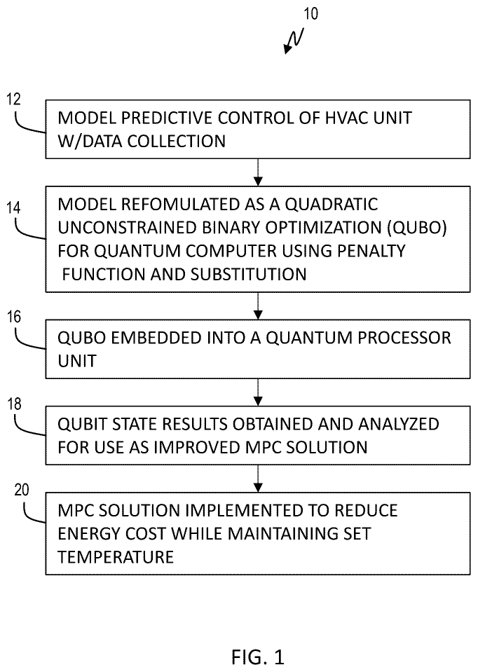

Referring to the figures, wherein like numeral refer to like parts throughout, there is seen in FIG. 1 an overview of an exemplary methodology 10 for an embodiment of the present invention that provides an optimization solution based on quantum annealing for model predictive control (MPC) of an HVAC rooftop unit (RTU). The real-time MPC of the RTU in the building was built with discrete fan stage variables to minimize the total coil load and electric price in the prediction horizon. A thermal network model was developed and then data collected to calibrate the model 12. The problem was formulated as a quadratic unconstrained binary optimization (QUBO) problem 14 by using a penalty function and the substitution method. The D-Wave quantum computer was used solve such optimization problem 16 and find the global optimum by outputting qubits states of 0/1 from the quantum processor unit (QPU) 18 for use in an optimized MPS solution. The optimal MPC solution for the RTU fan stages could then be implemented 20 to reduce energy usage.

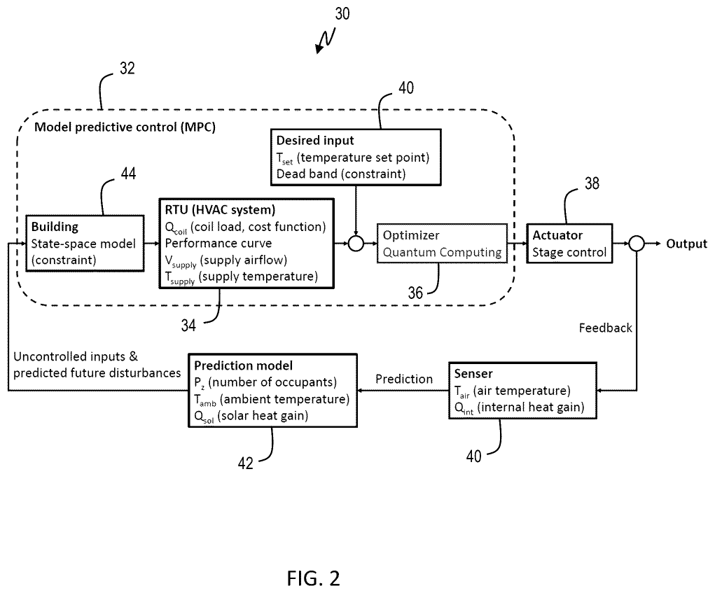

Referring to FIG. 2, an HVAC controller may be equipped with model predictive control (MPC) 22 for an HVAC system component 34, such as a rooftop unit (RTU). An optimizer 36 having a quantum computer according to the present invention is used to provide optimized commands to the actuator that controls the operation of HVAC system in response to any specific desired input 40, such as a set temperature in a location of the building. Sensors 40 are used to provide feedback, such as air temperature, heat gain, air flow temperature, air flow rate, etc. A prediction model 42 provide occupancy prediction, temperature prediction, solar heat gain using information obtained from additional sensors or outside data sources, such as occupancy sensors, ambient weather data, local weather predictions, etc. for the building state space model 44

The general MPC formulation for the building HVAC systems could be written in the following form:

$${min}_{{u}_{0} , … , {u}_{N - 1}} {\sum }_{k = 0}^{N - 1} {ℓ}_{k} ( {x}_{k} , {y}_{k} , {r}_{k} , {u}_{k} , {s}_{k} ) s . t . \\ {x}_{k + 1} = f ( {x}_{k} , {u}_{k} , {d}_{k} ) {y}_{k} = g ( {x}_{k} , {u}_{k} , {d}_{k} ) {s}_{k} = h ( {x}_{k} , {y}_{k} , {u}_{k} , {d}_{k} ) {x}_{0} = \hat{x} {x}_{k} ∈ X , {u}_{k} ∈ U , {s}_{k} ∈ S k ∈ {□}_{0}^{N - 1} \qquad ( 4 )$$

Where [symbol] ₖ was the objective function, xₖ the system states, yₖ the system outputs, rₖ the reference signal, uₖ the system inputs, sₖ the slack variables, dₖ the disturbances, x₀ the initial state, X the constraints for xₖ, U the constraints for uₖ, S the constraints for sₖ, k the time step, and N the prediction horizon. The optimal control would minimize the objective function, such as energy use or electric bill for the building HVAC systems affected by the disturbances and within the constraints of comfort and system bounds.

To solve this optimization problem by quantum computing, the constrained problem was first formulated as an unconstrained one by using penalty terms in the objective function for xₖ, uₖ, sₖ. Then, the system inputs uₖ were formulated in the form of binary qubits. Thus, the optimization could be reformulated in the following form:

$${min}_{{q}_{ki}} [ {ℓ}_{X} ( {x}_{k} ) + {ℓ}_{U} ( {u}_{k} ) + {ℓ}_{S} ( {s}_{k} ) + {\sum }_{k = 0}^{N - 1} {ℓ}_{k} ( {x}_{k} , {y}_{k} , {r}_{k} , {u}_{k} , {s}_{k} ) ] s . t . \\ {x}_{k + 1} = f ( {x}_{k} , {u}_{k} , {d}_{k} ) {y}_{k} = g ( {x}_{k} , {u}_{k} , {d}_{k} ) {s}_{k} = h ( {x}_{k} , {y}_{k} , {u}_{k} , {d}_{k} ) {x}_{0} = \hat{x} {u}_{k} = {u}_{k} ( {q}_{ki} ) k ∈ {□}_{0}^{N - 1} {q}_{ki} ∈ \{ 0 , 1 \} \qquad ( 5 )$$

Even the objective function, the state-space model, the system model, and the penalty function were non-linear, as long as [symbol] _{X}, [symbol] _{U}, [symbol] _{S}, [symbol] ₖ, f, g, h, uₖ were polynomial functions, the above objective function was a polynomial of qₖᵢ. As a result, the form of the objective function was the same as Eq (2). Previously, researchers have developed algorithms to convert the problem from PUBO to QUBO—from Eq (2) to Eq (3). Hence, quantum computing could solve the MPC problem for building HVAC systems. In the present invention, quantum computing was used to solve the non-linear mixed-integer programming for RTU optimal control as an example.

### MPC and Coil Load Calculation

The purpose of the MPC for building HVAC systems is to minimize the coil load or electric price used by an RTU, such as an EcoBlue technology 48GCM04, for cooling in summer, while maintaining the room air temperature around a set point when the room was occupied. When the room was unoccupied, setback control was applied to save energy. The optimization of the MPC for coil load may be written as

$${min}_{{s}_{t}} {\sum }_{t = k}^{k + M} {Q}_{coil} s . t . \dot{X} = AX + Bu + Ew 22 ° C . \leq {T}_{z} \leq 24 ° C . \\ when {P}_{z} > 0 ; 10 ° C . \leq {T}_{z} \leq 32 ° C . \\ when {P}_{z} = 0 \qquad ( 6 )$$

where sₜ was the discrete fan stage to be optimized, k the first optimization time step, k+M the last optimization time step, Q_{coil} the coil load, A the state of the building (i.e., wall temperature and zone air temperature), u the cooling load of the RTU, w the uncontrollable inputs including ambient air temperature, solar heat gain, and internal heat gains, T_{z} the zone air temperature, P_{z} the number of occupants. The constraints were that air temperature should be around the set point temperature 23° C. with a dead band of 1° C. Setback when unoccupied was 10° C. for the heating season and 32° C. for cooling.

The zone air temperatures at future time steps were predicted by the state-space model. For the MPC of building HVAC systems, the control time step was 15 minutes. In this example, a predictive horizon of 2, 3, 6, 12, and 24 hours was used. Thus, 8, 12, 24, 48, and 96 time steps in future horizons were optimized.

The electric price can vary due to the grid demand response. For example, the time-of-use energy rate during the peak time and off-peak time was different. In the summer season, when the outdoor air temperature is hot and grid stress is high, the electric price can be higher. As a result, the present invention could reduce the energy usage during the time of high grid stress and emergencies. The optimization of the MPC for electric price may be written as

$${min}_{{s}_{t}} {\sum }_{t = k}^{k + M} {Q}_{coil} \cdot price ( t ) \\ s . t . \\ \dot{X} = AX + Bu + Ew 22 ° C . \leq {T}_{z} \leq 24 ° C . \\ when {P}_{z} > 0 ; 10 ° C . \leq {T}_{z} \leq 32 ° C . \\ when {P}_{z} = 0 \qquad ( 7 )$$

where price(t) was the electric price per kWh. At each time step, we needed to manipulate the system inputs, the stage of fan sₜ, with the consideration of several future predictive horizons. Therefore, sₜ was a discrete variable with possible values 0, 1, or 2 to be optimized. Here 0 represented fan off status, while 1 and 2 represented stages I and II, respectively. Various stages of the fan represented different powers and speeds. It could be adjusted according to the need and circumstances for load requirement and energy efficiency.

Coil load at each time step using the following equations:

$${Q}_{coil} = {Q}_{ref} \cdot EIR \cdot {f}_{EIRT} \cdot {f}_{CCMT} \cdot {V}_{supply} \qquad ( 8 )$$

$${f}_{EIRT} = {C}_{0} + {C}_{1} {T}_{o} + {C}_{2} {T}_{o}^{2} + {C}_{3} {T}_{mix} + {C}_{4} {T}_{mix}^{2} + {C}_{5} {T}_{o} {T}_{mix} \qquad ( 9 )$$

$${f}_{CCMT} = {C}_{6} + {C}_{7} {T}_{o} + {C}_{8} {T}_{o}^{2} + {C}_{9} {T}_{mix} + {C}_{10} {T}_{mix}^{2} + {C}_{11} {T}_{o} {T}_{mix} \qquad ( 10 )$$

where the coil load was proportional to a given reference load, a constant energy input ratio (EIR), energy input ratio temperature (EIRT), and compressor control module temperature (CCMT). The performance curves of EIRT and CCMT were the non-linear functions of the outdoor air temperature Tₒ and the mixed air temperature Tₘᵢₓ. C₀˜C₁₁ were coefficients provided by the manufacturer, as Table 1 shows. Thus, the coil load was a quartic polynomial of Tₘᵢₓ.

TABLE 1
Value of coefficients to calculate EIRT and CCMT

| Coefficient | Value |
|---|---|
| C₀ | 1.2788 |
| C₁ | −0.0019315 |
| C₂ | −0.000239 |
| C₃ | −0.066933 |
| C₄ | 0.0010513 |
| C₅ | 0.00058568 |
| C₆ | 0.15979 |
| C₇ | −0.0012132 |
| C₈ | 5.4e−5 |
| C₉ | −0.0050051 |
| C₁₀ | 0.00025547 |
| C₁₁ | −0.00012701 |

The mixed air temperature in the duct was related to the stage of the fan sₜ, the outdoor air flow rate V_{o,t}, and the supply air flow rate V_{supply,t} as

$${T}_{mix , t} = \{ \begin{matrix}{T}_{o , t} , {s}_{t} = 0 \\ [ \frac{{V}_{o , t}}{{V}_{supply , t}} {T}_{o , t} + ( 1 - \frac{{V}_{o , t}}{{V}_{supply , t}} ) {T}_{z , t} ] , {s}_{t} = 1 or 2\end{matrix} \qquad ( 11 )$$

When the fan was off, the mixed air temperature was the same as the outdoor air temperature. When the fan was on, the mixed air temperature was the volume-weighted result of outdoor air temperature and zone return air temperature.

The required outdoor airflow rate of the RTU was based on the ASHRAE Standard 62.1 (ASHRAE, 2013) as

$${V}_{o . t} = \frac{{R}_{p} {P}_{z , t} + {R}_{a} {A}_{z}}{{E}_{z}} \qquad ( 12 )$$

where Rₚ was the outdoor air flow rate required per person, P_{z,t} the zone population, Rₐ the outdoor airflow rate required per unit area, A_{z} the zone floor area, E_{z} the zone air distribution effectiveness. In this study, we used Rₚ=8.5 m³/h per person, Rₐ=1.1 m³/h, A_{z}=68 m², and E_{z}=1

The supply airflow rate of the RTU at each time step was related to sₜ so that

$${V}_{supply , t} = \{ \begin{matrix}0 , & {s}_{t} = 0 \\ {V}_{1} , & {s}_{t} = 1 \\ {V}_{2} , & {s}_{t} = 2\end{matrix} \qquad ( 13 )$$

where V₁=0.32 m³/s (675 CFM) and 2=0.42 m³/s (900 CFM), which were provided by the manufacturer.

For predictive control, it is still necessary to predict the zone air temperature at future time steps for the predictive control. With Eqs (8)-(13), it is possible to calculate the coil energy use, whose total in the next several time steps would be minimized by the MPC. It was worth noting that for each additional optimization time step, the number of possible combinations of system inputs triples. As a result, when the number of predictive horizons and solution space is large, it is very difficult to find the optimum control quickly by traditional optimization methods. For coordinated control of several RTUs and large-scale MPC problems, the optimization would be even more difficult.

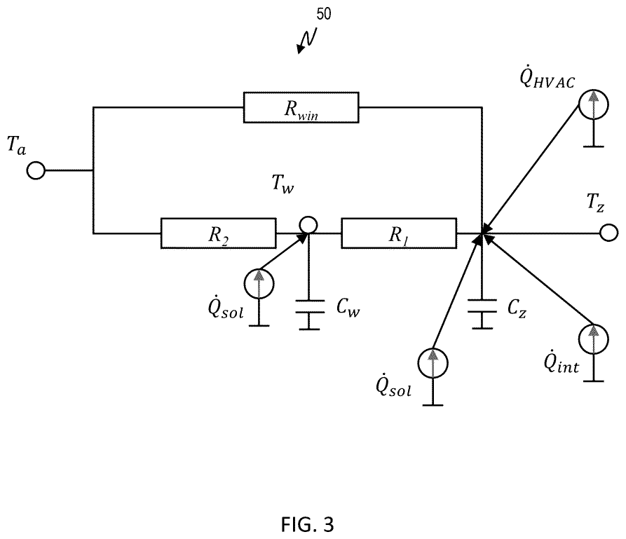

FIG. 3 shows a thermal resistance-capacitance (RC) network model 50 to predict the zone air temperature for the MPC. The governing equations of the state-space model for the wall temperature and zone air temperature were as follows:

$${\dot{T}}_{w} = \frac{{T}_{a} - {T}_{w}}{{C}_{w} {R}_{2}} + \frac{{T}_{z} - {T}_{w}}{{C}_{w} {R}_{1}} + \frac{{Q}_{sol}}{{C}_{w}} \qquad ( 14 )$$

$${\dot{T}}_{z} = \frac{{T}_{w} - {T}_{z}}{{C}_{z} {R}_{1}} + \frac{{T}_{a} - {T}_{z}}{{C}_{z} {R}_{win}} + \frac{{Q}_{HVAC} + {Q}_{int} + {Q}_{sol}}{{C}_{z}} \qquad ( 15 )$$

where Tₐ was the ambient air temperature, T_{w} the wall temperature, T_{z} the zone air temperature, Qₛₒₗ the heat gain from solar radiation on walls, Z_{HVAC} the heat gain from the HVAC system, Qᵢₙₜ the heat gains from internal sources, R_{win} the window thermal resistance, R₁ and R₂ the thermal resistance of the exterior wall, C_{w} the t exterior wall heat capacity, and C_{z} the zone heat capacity.

Eqs (14)-(15) may be written in matrix form as follows:

$$\dot{X} = AX + Bu + Ew \qquad ( 16 )$$

$$X = {[ {T}_{w} {T}_{z} ]}^{T} \qquad ( 17 )$$

$$A = [ \begin{matrix}- \frac{{R}_{1} + {R}_{2}}{{C}_{w} {R}_{1} {R}_{2}} & \frac{1}{{C}_{w} {R}_{1}} \\ \frac{1}{{C}_{z} {R}_{1}} & - \frac{{R}_{1} + {R}_{win}}{{C}_{z} {R}_{1} {R}_{win}}\end{matrix} ] \qquad ( 18 )$$

$$B = [ \begin{matrix}0 & {\frac{1}{{C}_{z}} ]}^{T}\end{matrix} \qquad ( 19 )$$

$$u = {Q}_{HVAC} \qquad ( 20 )$$

$$E = [ \begin{matrix}\frac{1}{{C}_{z} {R}_{2}} & \frac{1}{{C}_{w}} & 0 \\ \frac{1}{{C}_{z} {R}_{win}} & \frac{1}{{C}_{z}} & \frac{1}{{C}_{z}}\end{matrix} ] \qquad ( 21 )$$

$$w = {[ {T}_{amb} {Q}_{sol} {Q}_{int} ]}^{T} \qquad ( 22 )$$

The heat gain from the HVAC systems was calculated as

$${Q}_{H V A C} = {c}_{air} {ρ}_{air} {V}_{supply} ( {T}_{supply} - {T}_{z} ) \qquad ( 23 )$$

T_{supply} with 12° C. were used for cooling the room. For the other parameters of thermal resistance and heat capacity, d the collected data in the office was used to calibrate the values of these parameters.

The discretized state-space model of Eq (16) was

$${X}_{t} = {e}^{A T} {X}_{t - 1} + {A}^{- 1} ( {e}^{A T} - I ) B {u}_{t - 1} + {A}^{- 1} ( {e}^{A T} - I ) E {w}_{t - 1} \qquad ( 24 )$$

where I was the identity matrix.

Thus, the solution of the above discretized state-space RC model could be written as

$$[ \begin{matrix}{T}_{w , t} \\ {T}_{z , t}\end{matrix} ] = {e}^{A T ( t - 1 )} [ \begin{matrix}{T}_{w , 1} \\ {T}_{z , 1}\end{matrix} ] + {\sum }_{i = 1}^{t - 1} {e}^{A T ( t - 1 - i )} {A}^{- 1} ( {e}^{A T} - I ) {Bu}_{i} + {\sum }_{i = 1}^{t - 1} {e}^{A T ( t - 1 - i )} {A}^{- 1} ( {e}^{A T} - I ) {Ew}_{i} \qquad ( 25 )$$

### Data Collection

Data was collected in an office building at the Syracuse University campus and a people counting sensor was to collect the room occupancy data. The sensor used the depth sensor and infrared lasers to measure the entry movement. There were air temperature sensors, flow rate sensors, and smart meters installed in the room so that it was possible to monitor the zone air temperature, internal heat gain, supply air temperature, and supply air flow rate of the HVAC system by using a Building Automation and Control Networks (BACnet). Programming was perform in Python and the data were automatically read and stored in a PostgreSQL database. As for outdoor weather information, data was gathered from a Syracuse STEM weather station. The internal heat gain, outdoor weather data, and room occupancy data were also used in MPC as disturbances. Data was collected for five days in the summer season of 2021 and the frequency of data collection was 5 minutes.

### Binary Optimization for Quantum Computing

For the MPC optimization of the RTU, the objective function in Eqs (6)-(7) was for constrained optimization with discrete variables sₜ. The constrained optimization problem was reformulated to an unconstrained binary optimization so that it could become a PUBO as Eq (2), and further formulate it into QUBO as Eq (3) for quantum computing.

At first, the supply air flow rate and mixed air temperature in Eq (11) and (13) could be written in a unified form instead of the piecewise form as

$${T}_{mix , t} = \frac{( {s}_{t} - 1 ) ( {s}_{t} - 2 )}{2} {T}_{o , t} - {s}_{t} ( {s}_{t} - 2 ) [ \frac{{V}_{o , t}}{{V}_{1}} {T}_{o , t} + ( 1 - \frac{{V}_{o , t}}{{V}_{1}} ) {T}_{z , t} ] + \frac{{s}_{t} ( {s}_{t} - 1 )}{2} [ \frac{{V}_{o , t}}{{V}_{2}} {T}_{o , t} + ( 1 - \frac{{V}_{o , t}}{{V}_{2}} ) {T}_{z , t} ] \qquad ( 26 )$$

$${V}_{supply , t} = \frac{{s}_{t} ( {s}_{t} - 1 )}{2} {V}_{2} - {s}_{t} ( {s}_{t} - 2 ) {V}_{1} \qquad ( 27 )$$

Thus, V_{supply} and Tₘᵢₓ were quadratic polynomials of sₜ.

Then, with the thermal network model, it was possible to calculate the predicted state of zone air temperature and wall temperature at any time step by using Eq (25). The first and last terms were given constant at each time step, and V_{supply} in the second term was a quadratic polynomial of sₜ. So T_{z,t} was also a quadratic polynomial of sₜ.

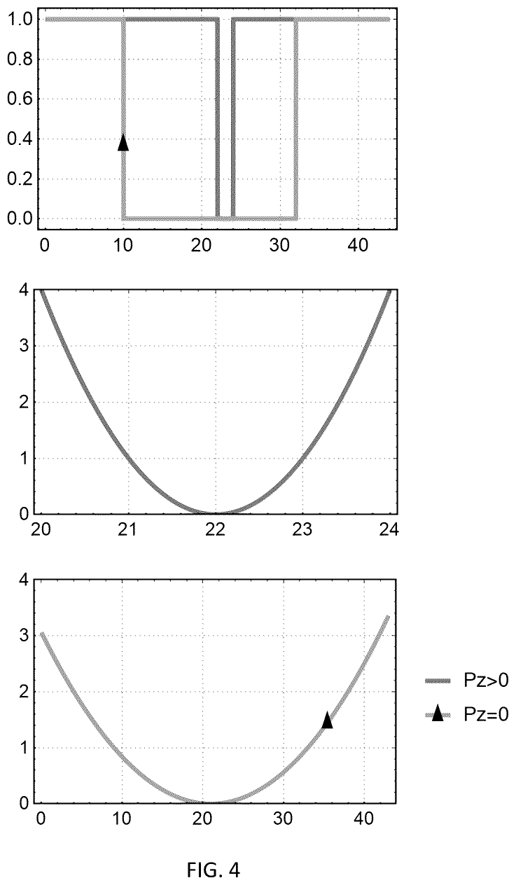

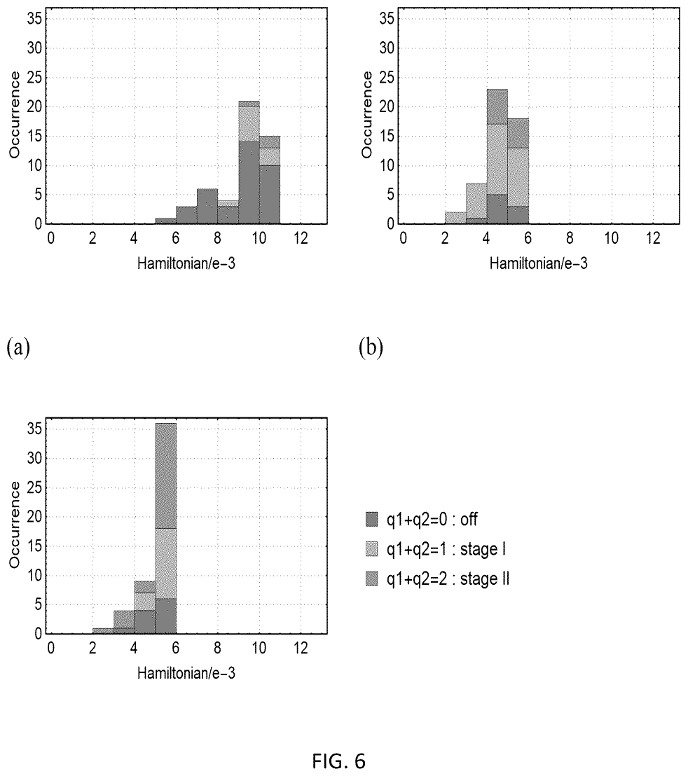

Next, there were constraints of zone air temperature in Eqs (6)-(7). For the present invention, a penalty function was used to add to the objective function to convert the constrained optimization to unconstrained optimization. The ideal penalty function was step functions as shown in FIG. 4(a). Since only polynomial optimization can be used for quantum computing, quadratic penalty functions were used when the room was occupied and unoccupied. FIGS. 4(b) and 6(c) show the penalty functions that were used:

$${f}_{p} = \{ \begin{matrix}{( {T}_{z} - 23 )}^{2} , {P}_{z} > 0 \\ {( \frac{{T}_{z} - 21}{12} )}^{2} , {P}_{z} = 0\end{matrix} \qquad ( 28 )$$

Therefore, the new objective function could be written as

$${min}_{{s}_{t}} {\sum }_{t = k}^{k + M} [ {Q}_{coil , t} + W \cdot {f}_{p} ( {T}_{z , t} ) ] \qquad ( 29 )$$

where W was a weight to control the importance between the coil load and the penalty of air temperature deviation. Large weight could increase the impact of deviations from the temperature set point. And fₚ(T_{z,t}) was a quadratic polynomial of sₜ.

Since the optimized stage of the fan in each time step sₜ∈{0,1,2}, two binary variables qₜ₁,qₜ₂∈{0, 1} were used to represent as

$${s}_{t} = {q}_{t 1} + {q}_{t 2} \qquad ( 30 )$$

Hence, it was possible to formulate the optimization of MPC into a binary optimization for any time step k as

$${min}_{{q}_{ti}} {\sum }_{t = k}^{k + M} [ {Q}_{coil , t} + W \cdot {f}_{p} ( {T}_{z , t} ) ] \qquad ( 31 )$$

$$s . t .$$

$$Eqs ( 8 ) - ( 10 ) , ( 12 ) , ( 24 ) - ( 28 ) , ( 30 )$$

$${q}_{t 1} , {q}_{t 2} ∈ \{ 0 , 1 \}$$

The objective function in above optimization problem was found to be a tenth-degree polynomial of the binary variables qₜᵢ. Note that

$${q}_{i}^{n} = {q}_{i} \qquad ( 32 )$$

when qᵢ∈{0,1} and n was a positive integer, the higher exponent terms could be further simplified and reduced to one.

After a simplification, the objective function was found to contain not only linear and non-linear second-order terms, but also three-order and four-order terms, as the following form:

$$H = {\sum }_{i} {C}_{i} {q}_{i} + {\sum }_{i , j} {C}_{ij} {q}_{i} {q}_{j} + {\sum }_{i , j , k} {C}_{ijk} {q}_{i} {q}_{j} {q}_{k} + {\sum }_{i , j , k , l} {C}_{ijkl} {q}_{i} {q}_{j} {q}_{k} {q}_{l} \qquad ( 33 )$$

Note that the constant term did not affect the optimization result, thus it was removed.

Then the high-order polynomials of objective function was reduced from four-order PUBO as Eq (2) into QUBO as Eq (3). Based on the Handbook of D-Wave quantum annealer (D-Wave, 2022a), the non-quadratic polynomials could be reformulated and reduced to quadratics by minimum selection method and substitution method.

Minimum selection method worked on only one term, by introducing an ancillary binary variable w, to minimize a cubic term of Cᵢⱼₖqᵢqⱼqₖ

$$min {C}_{ijk} {q}_{i} {q}_{j} {q}_{k} \qquad ( 34 )$$

$$s . t . {q}_{i} , {q}_{j} , {q}_{k} ∈ \{ 0 , 1 \} ⇔ \{ \begin{matrix}min {C}_{ijk} w ( {q}_{i} + {q}_{j} + {q}_{k} - 2 ) , {C}_{ijk} < 0 \\ min {C}_{ijk} [ ( w - 1 ) ( {q}_{i} + {q}_{j} + {q}_{k} - 1 ) + {q}_{i} {q}_{j} + {q}_{i} {q}_{k} + {q}_{j} {q}_{k} ] , {C}_{ijk} > 0\end{matrix}$$

Similarly, for minimization of a quartic term Cᵢⱼₖₗqᵢqⱼqₖqₗ

$$min {C}_{ijkl} {q}_{i} {q}_{j} {q}_{k} {q}_{l} \qquad ( 35 )$$

$$s . t . {q}_{i} , {q}_{j} , {q}_{k} , {q}_{l} ∈ \{ 0 , 1 \} ⇔ \{ \begin{matrix}min {C}_{ijkl} w ( {q}_{i} + {q}_{j} + {q}_{k} + {q}_{l} - 3 ) , {C}_{ijkl} < 0 \\ \begin{matrix}min {C}_{ijkl} \{ w [ - 2 ( {q}_{i} + {q}_{j} + {q}_{k} + {q}_{l} ) + 3 ] + \\ {q}_{i} {q}_{j} + {q}_{i} {q}_{k} + {q}_{i} {q}_{l} + {q}_{j} {q}_{k} + {q}_{j} {q}_{l} + {q}_{k} {q}_{l} \} , {C}_{ijkl} > 0\end{matrix}\end{matrix}$$

Since there was more than one high-order term in the objective function in Eq (33) of this study, we also used the substitution method (Boros, 2002). The algorithm was as follows: as long as there existed high-order terms containing qᵢqⱼ like Cᵢⱼₖqᵢqⱼqₖ or Cᵢⱼₖₗqᵢqⱼqₖqₗ in the polynomial of objective function H, we introduced an ancillary binary variable wᵢⱼ to replace qᵢqⱼ and looped through the operations as follows:

$${C}_{ij} {q}_{i} {q}_{j} = {C}_{ij} {w}_{ij} \qquad ( 36 )$$

$${C}_{ijk} {q}_{i} {q}_{j} {q}_{k} = {C}_{ijk} {w}_{ij} {q}_{k} \qquad ( 37 )$$

$${C}_{ijkl} {q}_{i} {q}_{j} {q}_{k} {q}_{l} = {C}_{ijk} {w}_{ij} {q}_{k} {q}_{l} \qquad ( 38 )$$

$$H = H + M [ {q}_{i} {q}_{j} - 2 ( {q}_{i} + {q}_{j} ) {w}_{ij} + 3 {w}_{ij} ] \qquad ( 39 )$$

Where H was the polynomial of objective function in Eq (33), and M (Boros, 2002) was defined as

$$M ▯ 1 + {\sum }_{ij} \vert {C}_{ij} \vert \qquad ( 40 )$$

The above Eq (39) was established since the minimum of H has not changed as the following two equivalences (Boros, 2002) for any qᵢ,qⱼ,wᵢⱼ∈{0,1} always hold:

$${q}_{i} {q}_{j} = {w}_{ij} ⇔ {q}_{i} {q}_{j} - 2 ( {q}_{i} + {q}_{j} ) {w}_{ij} + 3 {w}_{ij} = 0 \qquad ( 41 )$$

$${q}_{i} {q}_{j} \neq {w}_{ij} ⇔ {q}_{i} {q}_{j} - 2 ( {q}_{i} + {q}_{j} ) {w}_{ij} + 3 {w}_{ij} > 0 \qquad ( 42 )$$

From the above Eqs (36)-(39), the four-order PUBO as Eq (33) can be gradually reduced to QUBO. Similarly, the interaction of more than four variables could also be reduced by sequentially introducing new binary variables, but they did not appear in the objective function here. Finally, the problem could be written as QUBO in the form as Eq (3). And it could be mapped and solved by the D-Wave quantum computer.

### D-Wave Annealer Configuration

After reformulating the problem as the QUBO, and obtaining the linear coefficients and non-linear quadratic coefficients, the minor embedding would map them to the nodes and edge weights of the chimeric graph architecture of qubits in the QPU. With these qubit biases and coupling strengths on the D-Wave quantum computer, it could use quantum annealing to minimize the energy of this configuration. Therefore, the system could find the lowest energy state of this configuration, which corresponded to the global minimum of the objective function with high probability.

In order to find the optimal solutions to the QUBO problems, we used the D-Wave advantage, which was a commercial quantum computing equipment aiming to achieve quantum annealing. The D-Wave Advantage system contained a QPU with over 5000 qubits and 35000 couples among qubits. The QPU needed to operate at a temperature of 12 mK and be isolated from the surrounding environment. The topology structure of the QPU was Pegasus, as shown in FIG. 1, with the graph size of P16 and connectivity of Degree 15. After the quantum computer reached the low energy solution of the Hamiltonian after annealing as Eq (1), it could output the samples of states of the qubits. As a result, we could obtain the corresponding optimal solution of the QUBO and the original optimization problem for the RTU. The time of one annealing process on D-Wave Advantage was 2 μs. In order to obtain a reasonable optimal solution, the number of reads with 10000 times was used for the annealing process. Python was used to submit the coefficients of the QUBO to D-Wave annealer by a Leap cloud system (D-Wave).

### Comparison With Other Control Strategies and Traditional Optimization Method

### Baseline Control Strategy

To verify the results of the MPC by quantum computing, the energy saving of the MPC was evaluated and compared with other control strategies. The results were compared with fixed rule-based, on-off control coupling the setback control with ASHRAE Guideline 36 (ASHRAE, 2018). For on-off control, the temperature set point always equaled the occupied set point of 23° C. For setback control, the set point in occupied time was the same. In the unoccupied time before 8:00 and after 17:30, the set point was 32° C. The control algorithm at each time step was as follows:
If zone air temperature was higher than the set point, and fan stage was off→fan stage I.
If zone air temperature was higher than the set point and the one at the previous time step, and fan stage I was on→fan stage II.
If zone air temperature was lower than the set point and fan stage II was on→fan stage I.
If zone temperature was lower than the set point and cooling stage I was on→fan stage off.
Otherwise→keep the current fan stage.

### Traditional Optimization Method

To validate the feasibility and efficiency of quantum computing for MPC of building HVAC systems, the computing time was compared with traditional optimization methods. The non-linear discrete optimization of MPC was solved as Eq (31) by GA in the Global Optimization Toolbox in MATLAB R2021a. This is a popular algorithm that mimics a natural selection process that repeatedly modifies a population of individual solutions that are restricted to integral values. In order to obtain reasonable results, the population size was based on the number of binary variables to be optimized. The max stall generations was set as 50, and optimization function tolerance with 1e-4. In addition, the QUBO was also solved as Eq (31) by using Gurobi 9.0.1, which uses the cutting plane algorithm to find the optimized results for the mixed-integer quadratic programming. The optimal solution tolerance was set as 1e-4.

### EXAMPLE

### Collected Data

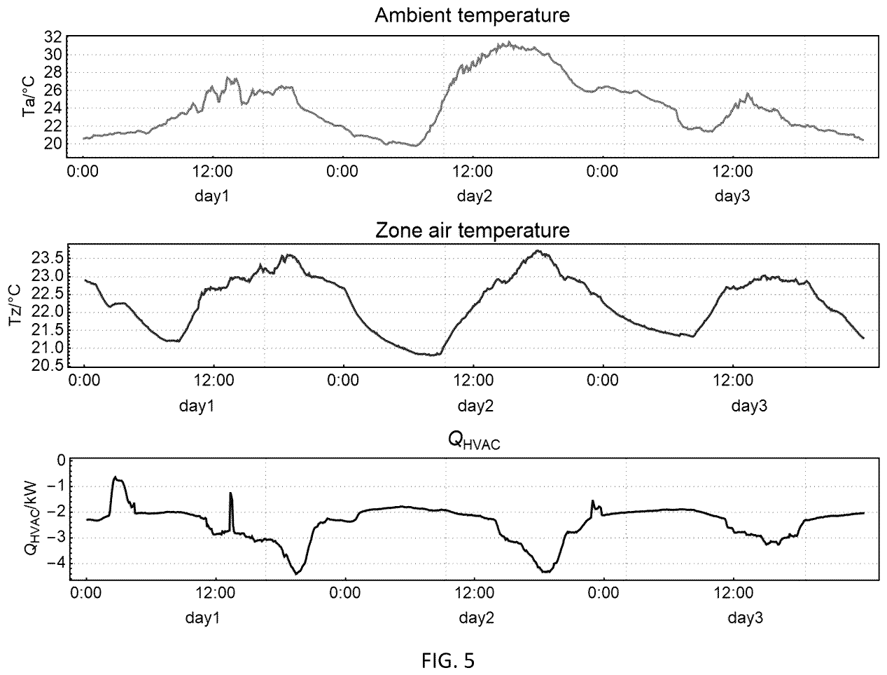

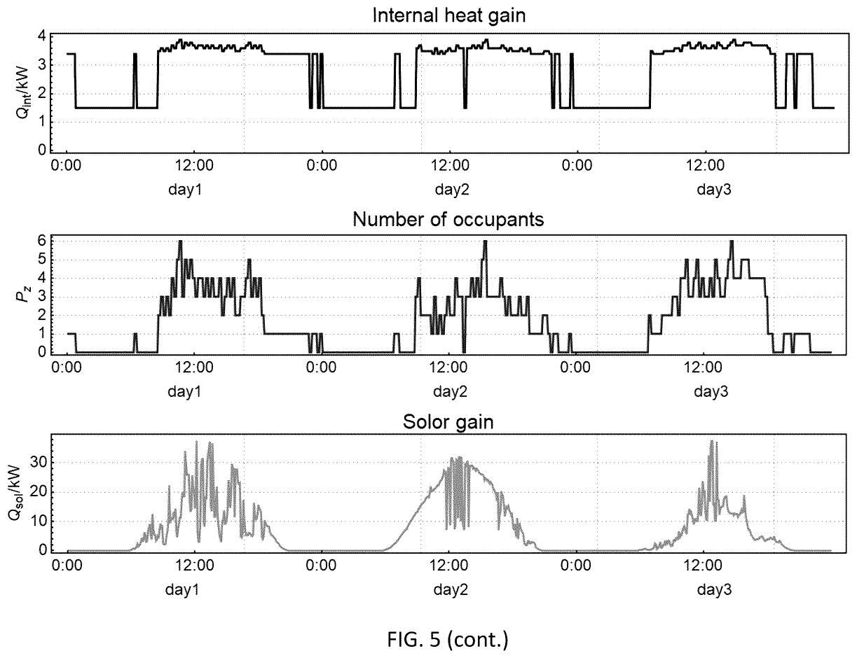

FIG. 5 shows the collected data of ambient air temperature, zone air temperature, Q_{HVAC} number of occupants, Qᵢₙₜ and Qₛₒₗ on three days in summer. This data was used to calibrate the RC model and obtained the values of the parameters. The ambient air temperature, the number of occupants in the room, solar heat gain, and the internal heat gain were also used for the MPC as disturbances.

### Results of Quantum Computing

After the reformulation, all the linear and quadratic coefficients of QUBO could be obtained for quantum computing. 10000 annealing samples in each time step that could obtain stable results with a high probability were obtained to reach the global minimum. Tables 2 and 3 list the outputs of quantum computing at the 20th and 60th time steps for a 3-hour prediction horizon, respectively. These two tables list ten sample results in the order of Hamiltonian energy from small to large, which was a very small fraction of all output results due to space. For each energy, the corresponding states of first 5 qubits were listed in the tables. q1+q2 with small Hamiltonian energy was found to have a high probability equal to 0 and 1 at 20th and 60th time steps, respectively. These results implied the optimal control of the fan stage at the 20th time step should turn off with a high probability. Similarly, at the 60th time step, it should be stage I.

TABLE 2
Outputs of quantum computing at 20th time step.

| Sample | q1 | q2 | q3 | q4 | q5 | . . . | energy |
|---|---|---|---|---|---|---|---|
| 1 | 0 | 0 | 0 | 0 | 0 | . . . | 5.246113e−3 |
| 2 | 0 | 0 | 1 | 0 | 0 | . . . | 6.526900e−3 |
| 3 | 0 | 0 | 0 | 0 | 0 | . . . | 6.535851e−3 |
| 4 | 0 | 0 | 0 | 0 | 0 | . . . | 6.535851e−3 |
| 5 | 0 | 0 | 0 | 0 | 0 | . . . | 7.294013e−3 |
| 6 | 0 | 0 | 0 | 0 | 0 | . . . | 7.295246e−3 |
| 7 | 0 | 0 | 0 | 0 | 0 | . . . | 7.522984e−3 |
| 8 | 0 | 0 | 0 | 0 | 0 | . . . | 7.962238e−3 |
| 9 | 0 | 0 | 0 | 0 | 0 | . . . | 7.973845e−3 |
| 10 | 0 | 0 | 0 | 0 | 0 | . . . | 8.037716e−3 |
| . . . | . . . | . . . | . . . | . . . | . . . | . . . | . . . |

TABLE 3
Outputs of quantum computing at 60th time step.

| Sample | q1 | q2 | q3 | q4 | q5 | . . . | energy |
|---|---|---|---|---|---|---|---|
| 1 | 0 | 1 | 1 | 0 | 0 | . . . | 1.695644e−3 |
| 2 | 1 | 0 | 1 | 0 | 0 | . . . | 3.110778e−3 |
| 3 | 0 | 1 | 1 | 1 | 0 | . . . | 3.475929e−3 |
| 4 | 1 | 1 | 1 | 1 | 0 | . . . | 3.591827e−3 |
| 5 | 1 | 0 | 1 | 1 | 0 | . . . | 3.996430e−3 |
| 6 | 0 | 0 | 1 | 0 | 0 | . . . | 4.008676e−3 |
| 7 | 0 | 0 | 0 | 1 | 0 | . . . | 4.280279e−3 |
| 8 | 1 | 1 | 1 | 1 | 0 | . . . | 4.314702e−3 |
| 9 | 1 | 1 | 1 | 1 | 0 | . . . | 4.314702e−3 |
| 10 | 0 | 1 | 0 | 0 | 0 | . . . | 4.443243e−3 |
| . . . | . . . | . . . | . . . | . . . | . . . | . . . | . . . |

FIG. 6 shows the occurrence distribution of 50 samples with the smallest Hamiltonian energy at the 20th, 70th, and 143rd time steps. As small energy represented a high probability of global minimum, in these time steps, the optimal controls were off, stage I and stage II, respectively.

Comparison of results and computing time with traditional optimization and control.

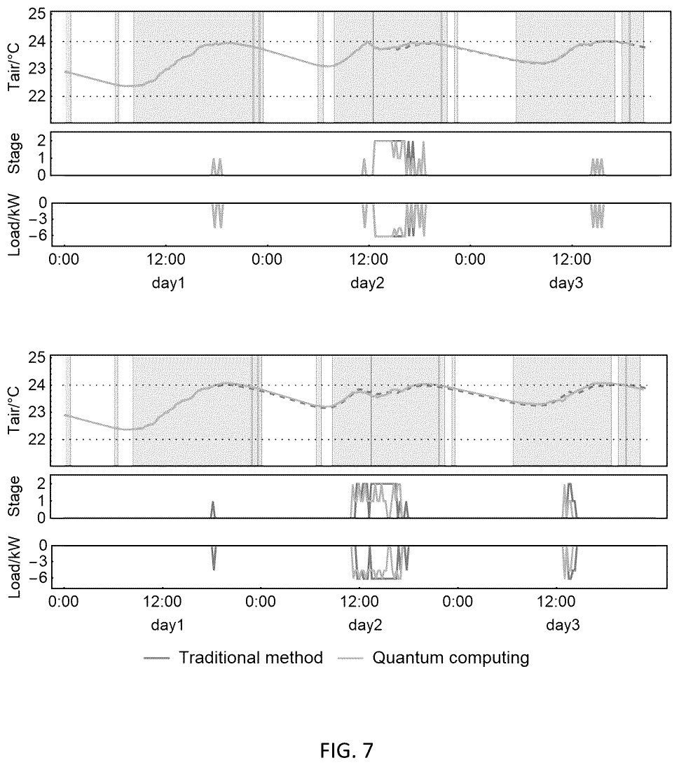

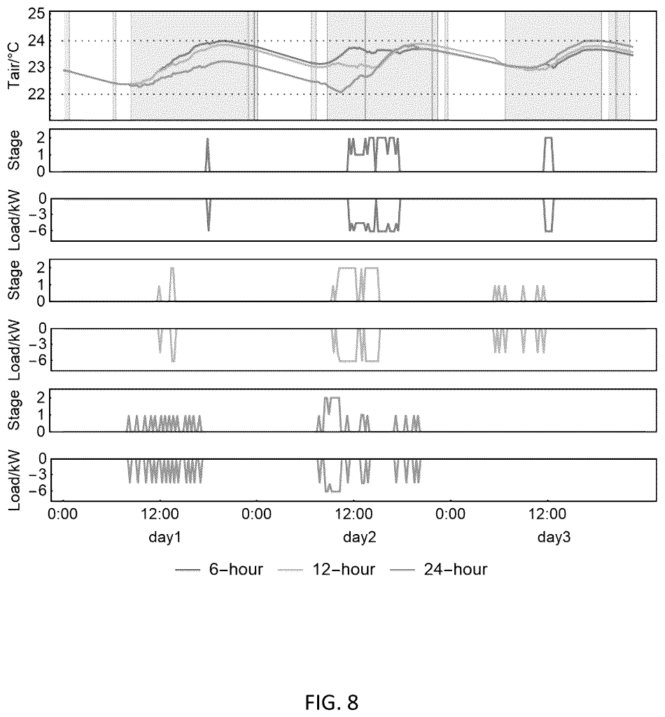

10000 annealing samples in each time step that could obtain stable results with a high probability were obtained to reach the global minimum. Then, the results of quantum annealing were analyzed at each time step to obtain the optimal control of the RTU fan stage. FIG. 7 shows the comparison of optimal air temperature control, fan stage, and cooling load between quantum computing and traditional methods for 2-hour and 3-hour prediction horizons. The RTU used the most cooling load on the second day. In the afternoon, when the outdoor air temperature and solar gain were high, the RTU started to work to cool down the room. After the working hour, and at night, the RTU did not work to save energy. The different optimal control results between quantum computing and the traditional optimization method occurred in a total of 6 time steps, which was 2.1% over three days. The predicted cooling load by quantum computing was 1.1% more than the traditional method. This result showed that quantum computing could obtain optimization results similar to the traditional optimization method. FIG. 6 also shows the predicted air temperature could be controlled within the upper bound of the set point as thermal comfort level by quantum computing. FIG. 7 compares the results of optimal air temperature control, fan stage, and cooling load for quantum computing with 6-hour, 12-hour, and 24-hour prediction horizons. Although most of the cooling load was still used on the second day, the total cooling load did not vary a lot with different prediction horizons. These results were very hard to obtain with traditional methods.

Fixed on-off control with occupancy information was still used for many buildings. Compared with this baseline control, we found that the MPC optimized by the traditional optimization method could save cooling load by 43.5%. The MPC optimized by quantum computing could save 42.9% of cooling load. The energy-saving by quantum computing and the traditional optimization method was therefore similar. Hence, we could use quantum computing to optimize the MPC of building HVAC systems the same as the traditional method.

TABLE 4
Comparison of computing time between quantum computing
(QC) and traditional optimization methods

| | | | | | Number of | Computing time for each | | | | | |
|---|---|---|---|---|---|---|---|---|---|---|---|
| | | Number | Number of | Number of | non-linear | time step | | | | | |
| Prediction | | of time | discrete | binary | quadratic | | | | | | |
| horizon | | steps | stages | variables | terms | GA | | Gurobi | | QC | |
| 2 | h | 8 | 24 | 72 | 237 | 8 | s | 0.4 | s | 1 | s |
| 3 | h | 12 | 36 | 159 | 777 | 21 | s | 36 | s | 1 | s |
| 6 | h | 24 | 72 | 577 | 5430 | 207 | s | >4 | h | 1 | s |
| 12 | h | 48 | 144 | 2305 | 22938 | 26 | min | >12 | h | 6 | s |

| | | | | | | | | | | |
|---|---|---|---|---|---|---|---|---|---|---|
| 24 | h | 96 | 288 | 9217 | 94405 | >12 | h | — | 37 | s |

As for the computing time, adding the sampling time, readout time and delay time for the quantum computer, the total QPU time for one time step optimization was less than 1 s when the prediction horizon was no more than 6 hours. It was almost the same for various prediction horizons and the number of binary variables. That was because the quantum annealing and sampling could be operated for all the qubits on QPU simultaneously, and it was a real parallelized calculation. In this case, raising the predictive horizon or the number of optimizing variables would not significantly increase the time of quantum computing. When the prediction horizon was 12 hours, there were more than 2000 binary variables and 20000 non-linear terms, the quadratic matrix was not sparse and the problem could not be directly embedded in the QPU architecture. The quantum computer needed to use the decomposer to divide the optimization problem into subproblems to solve. This required some iterative algorithms. Thus, the quantum computing time for 12 h and 24 h prediction horizons was 6 s and 37 s, respectively. Such computing time was still much shorter than the control time step with 15 minutes. Hence, quantum computing could respond quickly for larger problems and achieve real-time optimization.

The MPC of RTU optimization was performed for more predictive horizons by traditional optimization methods. For GA, it could find the optimal solution quickly when the number of binary variables was 72 and 159 in 2 h and 3 h prediction horizons, respectively. But Table 4 shows that the computing time for each time step was 26 minutes and over 12 hours when the prediction horizon was 12 hours and 24 hours, respectively. That was because the number of both binary optimized variables and non-linear terms was huge. The program ran a longer time to obtain a converged result. Similarly, as for the Gurobi method, it could solve the optimization problem with 159 binary variables in 36 s. However, when there were 577 and 2305 binary variables in the non-linear quadratic optimization problem, it could not solve the problem within 4 hours and 12 hours, respectively. Therefore, only quantum computing could achieve real-time optimization if the prediction horizon was more than 12 hours. The computing time of quantum computing for solving the quadratic optimization was greatly reduced to less than 0.4% of that by traditional optimization methods. For traditional optimization methods, increasing the predictive horizon and number of optimizing variables would significantly increase the time of optimization calculation. A problem with more discrete optimization variables can thus take advantage of quantum computing. Therefore, quantum computing has greater potential for large-scale optimization problems and even NP-hard problems.

TABLE 5
Total electric bills and peak usage calculated by baseline control
and quantum computing with various prediction horizons

| Prediction | Total electric | Electric bill | Peak | Peak load |
|---|---|---|---|---|
| horizon | bill/$ | reduction | load/kWh | reduction |
| Baseline control | 20.63 | — | 33.90 | — |
| 2 h | 20.51 | −0.6% | 28.89 | −15% |
| 3 h | 19.07 | −7.5% | 21.96 | −35% |
| 6 h | 18.02 | −13% | 5.39 | −84% |
| 12 h | 17.12 | −17% | 1.54 | −95% |
| 24 h | 16.31 | −21% | 7.02 | −79% |

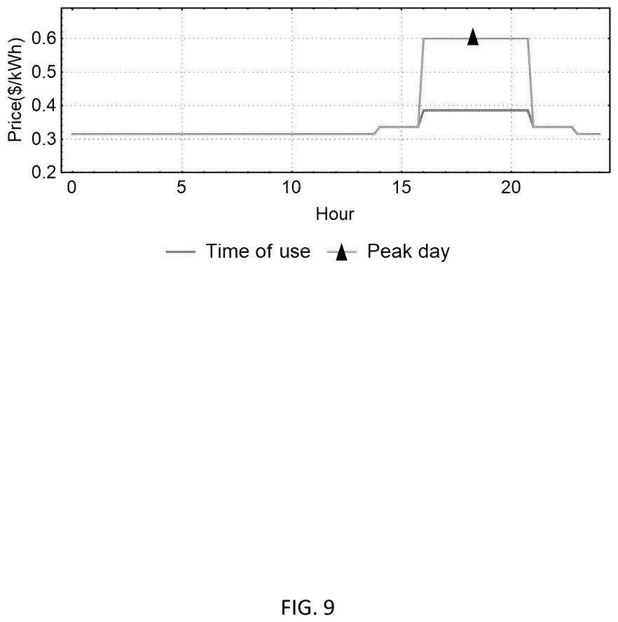

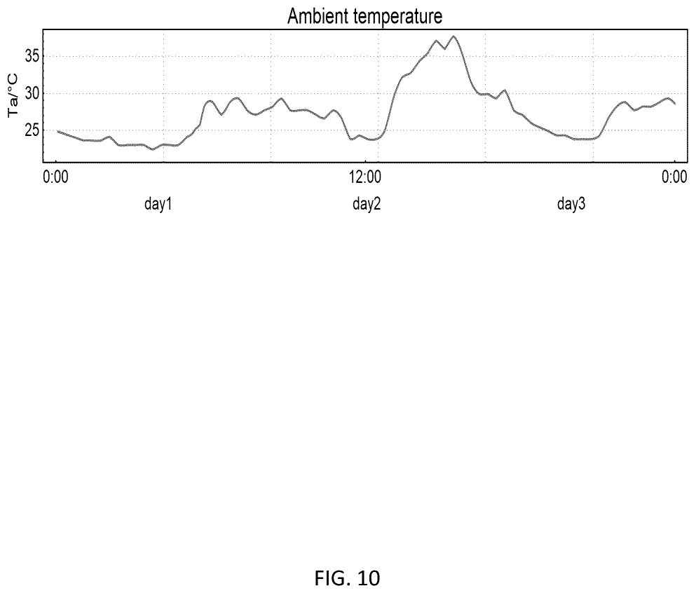

To reduce the load and the electric price during peak times, the MPC was used to optimize the fan stage of the RTU. FIG. 9 shows the electric price for the time-of-use rate and peak day rate (PGE, 2022). The time-of-use rate for peak, part-peak, and off-peak hours on normal days was $0.38551, $0.33628, and $0.31547 per kWh, respectively. In summer, the peak time was 4 pm to 9 pm, and part-peak time was 2 pm to 4 pm and 9 pm to 11 pm. As for the peak hour on the peak day, the trigger temperature was around 36.7° C. (98° F.). The electric rate for the peak hour on the peak day was $0.6 per kWh. The participants would be notified one day ahead before the peak day occurred to respond to the grid signal and arrange the electric usage to reduce the load. Therefore, to optimize the operation of the RTU for the peak day, the actual outdoor air temperature during Sep. 5th-7th 2020 in summer in Los Angeles was used, as FIG. 10 shows. On Sep. 6th during the peak day, the highest air temperature was about 37° C. in the afternoon.

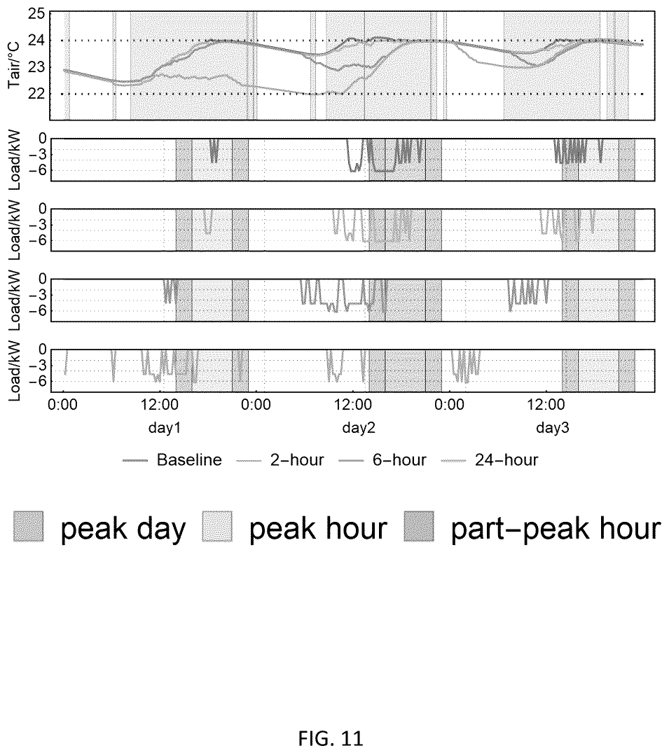

FIG. 11 shows the optimal air temperature control, fan stage, and cooling load by quantum computing for low electric prices with different prediction horizons. By MPC, the cooling load could be rescheduled to part-peak and off-peak hours. Especially for 12 h and 24 h ahead prediction horizon, all the cooling load was not in the peak day. Table 5 lists the electric bills calculated by quantum computing for 2 h, 3 h, 6 h, 12 h, and 24 h prediction horizons. By using quantum computing, the total electric bill could be reduced by 21% compared with the baseline ruled-based on-off control. As for the peak hour reduction, FIG. 13 also shows that most of the electric load was on the peak day and peak hours for baseline control. But for MPC, 12 h and 24 h prediction control greatly reduced the load in the peak hour and peak day. Table 5 shows that the peak load reduction could be 95% and 79% compared with baseline control for 12 h and 24 h prediction horizons, respectively. So quantum computing also significantly reduced the grid stress during the peak time. Such optimization could not be achieved by traditional optimization methods. Therefore, for the complex day ahead time-of-use demand response scenarios, only quantum computing could achieve real-time MPC to minimize the electric usage of the RTU and grid stress.

### Discussion

The present invention thus employs quantum computing to solve the optimization of energy-efficient model predictive control of RTU in an office building by reformulating the optimization to the QUBO for a D-Wave quantum computer, which is the only commercial quantum computer currently available. Currently, the architectures of quantum computing were still in the early stage of development that had limitations in the ease of computation, performance, and even algorithm. D-Wave Advantage system could only use limited qubits and their coupling in the QPU for direct embedding. Large-scale problems still needed to be decomposed into many sub-problems to be solved. This required the assistance of traditional algorithms, thus the computing time would increase. For the quantum computer, some factors such as error correction, decoherence qubits, and limited quantum control lead to obstacles of accuracy of quantum computing. To improve the precision of optimization, increasing annealing time and spin reversal transform were feasible ways, but they would also lead to more computing time. What is more, quantum computing required reformulation of the original problem to a specific format, thus not all the optimization problems could be solved. As long as the final objective function was polynomial, even for non-linear problems, quantum computers could solve it. From an optimization perspective, annealing-based quantum computers were closer to discrete optimization problems than gate-model quantum computers. This was because annealing was specifically built for optimization, whereas gate quantum computers followed general computing methods.

The use of quantum computing to solve the mixed-integer non-linear optimization of MPC for the building HVAC systems according to the present invention led to the following conclusions. First, the original MPC of RTU optimization as a non-linear problem with discrete variables could be formulated as the QUBO, so that quantum computers could solve it. Second, using quantum computing, it is possible to obtain a similar solution as using the traditional optimization methods with a short prediction horizon, and the control differences were less than 2%. For a longer prediction horizon, the computing time of quantum computers for solving the optimization problem was greatly reduced to less than 0.4% of that of traditional methods. Only quantum computing could achieve real-time optimization and respond to the control signal within 15 minutes. A problem with more discrete optimized variables thus could take advantage of quantum computing. Third, an MPC optimized by the traditional method and quantum computing could save the cooling load by 43.5% and 42.9% compared with on-off control, respectively. Finally, day-ahead real-time MPC by quantum computing could reschedule the electric usage of the RTU to off-peak hours by 80% and reduce the electric bill by 21%. Therefore, quantum computing has the potential to solve large-scale non-linear optimization problems for building energy systems.

What is claimed is:

1. A controller for a building heating, ventilation, and air conditioning (HVAC) system, comprising:
a processor programmed to implement a model predictive control unit to control the operation of HVC system component;
a first input for receiving a desired temperature setting for a location serviced by the HVAC system component;
a second input for receiving data from at least one temperature sensor in the location;
a third input for receiving data from at least one occupancy sensor reflecting occupancy in the location; and
a quantum processing unit programmed to perform a non-linear model predictive control strategy in real-time and provide control instructions to the model predictive control unit, wherein the non-linear model predictive control strategy uses a quantum annealer to minimize an amount of energy used to achieve the desired temperature setting over a predetermined prediction horizon.

2. The controller of claim 1, wherein the quantum processing unit is programmed to perform a non-linear model predictive control strategy in real-time according to a predicted occupancy.

3. The controller of claim 2, wherein the amount of energy used is based on a coil load of the HVAC system component.

4. The controller of claim 3, wherein the minimization of the amount of energy includes an electricity price.

5. The controller of claim 4, further comprising a fourth input for receiving data from at least one flow sensor associated with the HVAC system component.

6. The controller of claim 5, further comprising a fifth input for receiving data from at least one temperature sensor associated with a flow of air from the HVAC system component.

7. The controller of claim 6, wherein the predetermined prediction horizon is selected from group consisting of two hours, three hours, six hours, twelve hours, and twenty-four hours.

8. A method of controlling a building heating, ventilation, and air conditioning (HVAC) system, comprising:
providing a controller having a processor programmed to implement a model predictive control unit to control the operation of HVC system component, wherein the controller has a first input that receives a desired temperature setting for a location serviced by the HVAC system component, a second input that receives data from at least one temperature sensor in the location, and a third input that receives data from at least one occupancy sensor reflecting occupancy in the location; and
performing a non-linear model predictive control strategy in real-time with a quantum processing unit associated with the controller to provide control instructions to the model predictive control unit, wherein the non-linear model predictive control strategy uses a quantum annealer to minimize an amount of energy used to achieve the desired temperature setting over a predetermined prediction horizon.

9. The method of claim 8, wherein the quantum processing unit performs a non-linear model predictive control strategy in real-time according to a predicted occupancy.

10. The method of claim 9, wherein the amount of energy used is based on a coil load of the HVAC system component.

11. The method of claim 10, wherein the minimization of the amount of energy includes an electricity price.

12. The method of claim 11, wherein the controller has a fourth input for receiving data from at least one flow sensor associated with the HVAC system component.

13. The method of claim 12, further comprising a fifth input for receiving data from at least one temperature sensor associated with a flow of air from the HVAC system component.

14. The method of claim 13, wherein the predetermined prediction horizon is selected from group consisting of two hours, three hours, six hours, twelve hours, and twenty-four hours.
